(19) United States
(12) Patent Application Publication
(10) Pub. No.: US 2003/0183669 A1
(43) Pub. Date: Oct. 2, 2003

(54) Motorcycle case and backpack that protects computers

(76) Inventor: Carl A. Cameron, Silver Spring, MD (US)

Correspondence Address: Carl A. Cameron, 917 Hyde Road, Silver Spring, MD, 20902, US

(21) Appl. No.: 10/106,997

(22) Filed: Mar. 28, 2002

(51) Int. Cl. B62J 7/00; B62J 9/00; B62J 11/00; A45F 4/00; A45C 15/00; A45F 3/04

(52) U.S. Cl. 224/585; 224/644; 224/413; 224/427

(57) ABSTRACT

A unique multi-use carrying case that can be used as motorcycle luggage or a backpack because of a dual-strapping system is described. The motorcycle case and backpack involves a horizontal strapping system for use with a motorcycles backrest and a vertical strapping system for use as a backpack. A system of panels prevents the two sets of straps from interfering with one another and provides for the comfort of the wearer of the backpack. An internal padding structure makes possible the safe transportation of a laptop computer on a daily basis by motorcycle or by person. The case is also capable of carrying clothes that are hung in one of its compartments.

### BACKGROUND OF THE INVENTION

An invention is directed to a carrying case designed to safely and comfortably transport a laptop computer, books, clothes, and/or other goods, which may be strapped to a person, a motorcycle, or carried by hand. The case is relatively light in weight, yet sturdy and protective of the sensitive goods it contains.

The present invention is designed to satisfy the needs of professionals, students and others who ride motorcycles to work and/or school and must carry delicate computer equipment. Traditionally, motorcycles were low cost means of transportation for those who could not afford cars. Yet, in today's world a worker's ability to have access to a computer is a vital key to success in an increasing number of fields. The present invention is designed to assist entry-level professionals, students and anyone else who desires a comfortable, safe and efficient means of transporting their technological equipment and other belongings, such as books and clothes.

It is difficult, inconvenient, and potentially dangerous for a motorcyclist to carry multiple bags when traveling. A motorcycle relies upon centrifugal force to remain upright and one that is imbalanced is more likely to have an accident if less than optimal road conditions are encountered. Because of this invention, it will no longer be necessary for motorcyclists to carry a separate bag for each type of good the person must use.

1. Field of the Invention

The present invention generally relates to the field of carrying cases. More particularly, the invention relates to motorcycle luggage that will enable motorcycle riders and others who use laptop computers to safely transport them cross-country.

2. Description of the Prior Art

Traditionally, motorcycle luggage comes in the form of saddlebags (that are thrown across the seat), tank bags (that are affixed to the gas tank in front of the rider via magnets), or rear luggage (that is strapped to the backrest bar behind the rider). These luggage systems are generally rigid leather or plastic and contain no padding. They were created to carry durable goods such as clothes, books or food, but not computers.

Ordinary backpacks lack adequate padding to protect a computer being transported great distances repeatedly. Backpacks made especially for laptop computer users were not made with motorcyclists as a focus. A rider's back will become weary and begin to ache if he/she travels a great distance with a full pack on his/her back. Being able to strap the pack to the motorcycle will alleviate this problem.

The following three (3) motorcycle luggage systems represent prior art patents that are pertinent to the field of motorcycle carrying cases:

1. U.S. Pat. No. 4,588,114 issued to Lebaron, et al. on May 13, 1986 for “Baggage device for motorcycles and the like” (hereafter the “Lebaron Patent”).

The Lebaron Patent discloses a base for removably mounting a carrier box is permanently fixed on a motorcycle baggage-carrier frame. The underface of the carrier box has a recessed portion with grooves at each end for slidably engaging the carrier box on flanges of the base and locking the box in position by means of a latch mechanism, thus providing a theft-proof device and enabling the user to remove the box and carry it by hand in the same manner as a briefcase or suitcase.

2. U.S. Pat. No. 4,125,213 issued to Watkins on Nov. 14, 1978 for “Collapsible luggage for motorcycle” (hereafter the “Watkins Patent”).

The Watkins Patent discloses a collapsible luggage device for a motorcycle comprising three rigid panels hinged together forming the base or bottom, forward upright and top. The bottom panel is rectangular in planular outline, the forward upright panel is trapezoidal in planular outline and the top panel is rectangular in planular outline, each thereof being dimensionally reduced from the preceding panel to which it is hingedly connected. The balance of the sides comprise a flexible material, the rearward side of which is formed with a zippered opening, the bottom edge of which is releasably buttoned to the rear edge of the bottom panel. The bottom side of the base panel is provided with fixed forward clamping members and a rearward pivotable clamp for releasable connection to the cross bars of a conventional luggage rack of a motorcycle. A belt means is provided adjacent the top of the front upright panel for carrying the luggage when dismounted from the luggage rack and for encircling the backrest of the motorcycle seat when attached to the luggage rack. One of the novel functions of the progressively diminishing dimensions of rigid panels, besides providing a streamlined appearance, is that the folding pattern for the flexible sides remains constant with a minimum of manual guiding when it is desired to collapse the luggage panels. Also, the collapsed luggage may serve as a briefcase in that entrance for flat material such as papers and files may be gained for insertion thereof by unbuttoning the flexible material connected to the rear edge of the bottom panel.

3. U.S. Pat. No. 6,299,042 issued to Smith on Oct. 9, 2001 for “Touring bag support for motorcycles” (hereafter the “Smith Patent”).

The Smith Patent discloses a touring bag support that is secured on top of a motorcycle luggage rack. A touring bag is secured to the support in a variety of ways. The bottom of the touring bag remains flat and stable on the support because the support is longer and wider than the touring bag and the motorcycle luggage rack. A plurality of slots on an outer perimeter of the support allow for easy attachment of the touring bag to the support by bungee cords and straps. The touring bag support provides a safe, stable load on the rear of the motorcycle Further, an overall neat, aesthetically pleasing appearance is also provided.

The following three (3) combination-backpack devices represent prior art patents that are pertinent to the field of carrying cases:

4. U.S. Pat. No. 6,336,577 issued to Harris, et al. on Jan. 8, 2002 for “Backpack cooler” (hereafter the “Harris Patent”).

The Harris Patent discloses a backpack cooler designed to be worn on the back of a person that includes a flexible enclosure having backpack straps affixed to the enclosure. The enclosure includes front, rear, side and bottom walls and an openable top panel. The walls and panel include an outer fabric layer, inner foil facing and thermal insulation between the layer and facing. A flexible, water-impervious synthetic resin liner is situated within the enclosure. The cooler may be equipped with external pockets.

5. U.S. Pat. No. 6,343,968 issued to Louie, et al. on Feb. 5, 2002 for “Combined sleeping bag, character display item, and backpack” (hereafter the “Louie Patent”).

The Louie Patent discloses an elongated sleeping bag that is proportioned to resemble a character when it is in an elongated, flat state on a relatively flat surface. An element resembling the head of a character is attached to the sleeping bag facing in the same direction as the front panel of the sleeping bag. The head element contains a pouch into which the sleeping bag can be stuffed so as to form a base or floor on which the head can stand for storage or display. Shoulder straps are attached to the head to permit carrying of the entire assembly as a backpack when the sleeping bag is stored within the pouch. Accessories can likewise be attached to the head. The combined sleeping bag, character display item, and backpack is primarily intended for use by children but could be fabricated for uses ranging from dolls to adults.

6. U.S. Pat. No. 6,345,862 issued to Meinburg on Feb. 12, 2002 for “Convertible backpack chair”(hereafter the “Meinburg Patent”).

The Meinburg Patent discloses a convertible backpack chair device. The device has a first frame portion and a second frame portion. The two portions are independent of one another and are able to be slip fitted in a chair mode, a reclining mode, and a backpack mode. In the backpack mode, the second frame portion nests within the first frame portion for convenient carrying and storage. Backpack straps may also be present to facilitate convenient carrying.

### BRIEF SUMMARY OF THE INVENTION

The present invention is a unique multi-use carrying case that can be used as motorcycle luggage or a backpack. It is a backpack that may be strapped to the backrest bar of a motorcycle, by way of three hook-and-loop Velcro straps. Intended users may include cross-country travelers, office workers, students or anyone who wants to transport a laptop computer safely, whether they ride a motorcycle or not.

The invention will consist of three compartments of varying size and two side pockets. The middle compartment of the device will have a layer of padding on the front, back, sides and bottom to protect the laptop computer. The largest compartment will be capable of carrying books, clothes, food, or other sizable goods. Clothing on a hanger may be carried inside the largest compartment by hanging them from a rectangular ring of metal that is securely stitched to the rear panel of the backpack via a piece of leather. The smallest compartment will be designed to carry miscellaneous papers, electrical power cords for the laptop or other small goods. The side pockets will be sufficiently sized to carry cell phones, wallets, snacks, pens, business cards or other small goods.

A main feature of the present invention will be its dual-strapping system. The invention will possess three horizontal Velcro straps that will enable the case to be attached to the motorcycle's backrest (sissy bar) in a hook-and-loop manner. The invention will also possess two wide and thickly padded vertical straps that will enable the case to be worn as a backpack. The two horizontal straps will emerge from a pocket with a zipper that is centered at the top of the bag and is 7.00 inches in width. This means that the back of the bag will have to be made of two layers of material. This is necessary so that when the bag is held to a motorcycle by the three horizontal straps, the two backpack straps are out of the way and not flapping about in the wind. The backpack straps will lie flat within this pocket. When the backpack straps are pulled out of the pocket, metallic clips on their ends may be used to fasten them to the metal D-rings that are attached to the bottom, rear portion of the bag. The straps will be adjustable so persons of different sizes my comfortably wear the bag.

To prevent the three motorcycle attachment straps from irritating the back of a person who is wearing the bag as a backpack, a padded flap that covers the back of the largest compartment will be attached to the back of the bag. It will have a zipper that goes all the way around the sides and top of the bag. This flap will not cover the 7.00-inch zippered opening for the backpack straps; otherwise it cannot be used as a backpack when the protective flap is in place. The stitching for the three horizontal motorcycle attachment straps will be far enough away from the line of the flap's zipper so that the zipper will be able to move freely. The three straps will not impede its motion.

### BRIEF DESCRIPTION OF THE SEVERAL VIEWS OF THE DRAWING

FIG. 1 is a perspective view of the present invention, motorcycle case and backpack that protects computers.

FIG. 2 is a plan view of the front of the present invention, motorcycle case and backpack that protects computers.

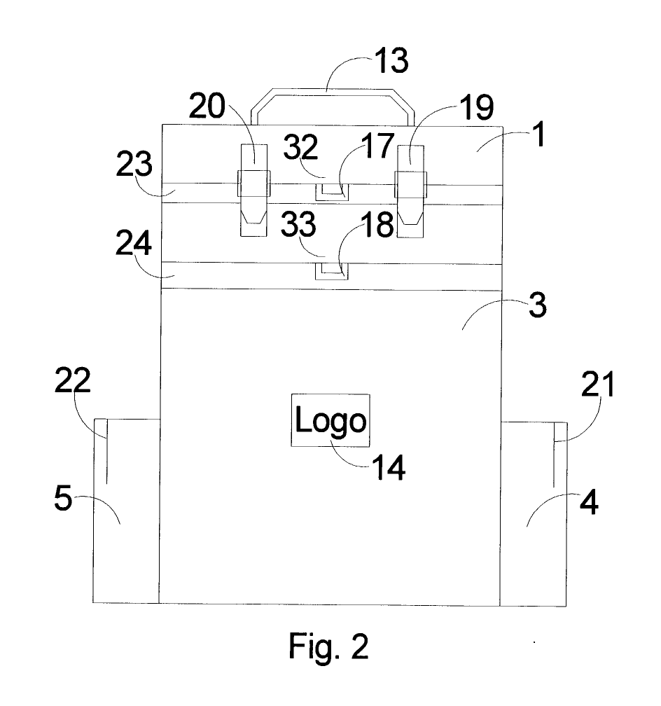

FIG. 3 is a plan view of the back of the present invention, motorcycle case and backpack that protects computers.

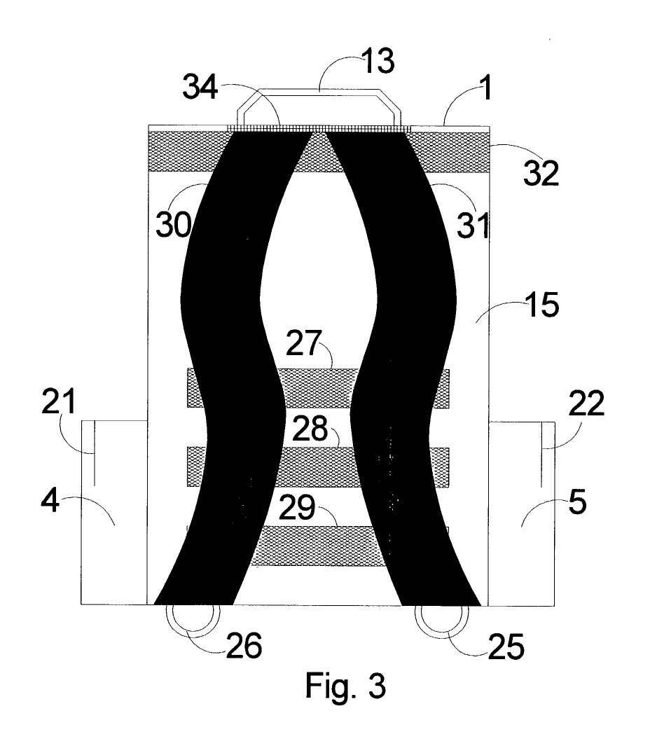

FIG. 4 is a sectional view of the right side of the present invention, motorcycle case and backpack that protects computers.

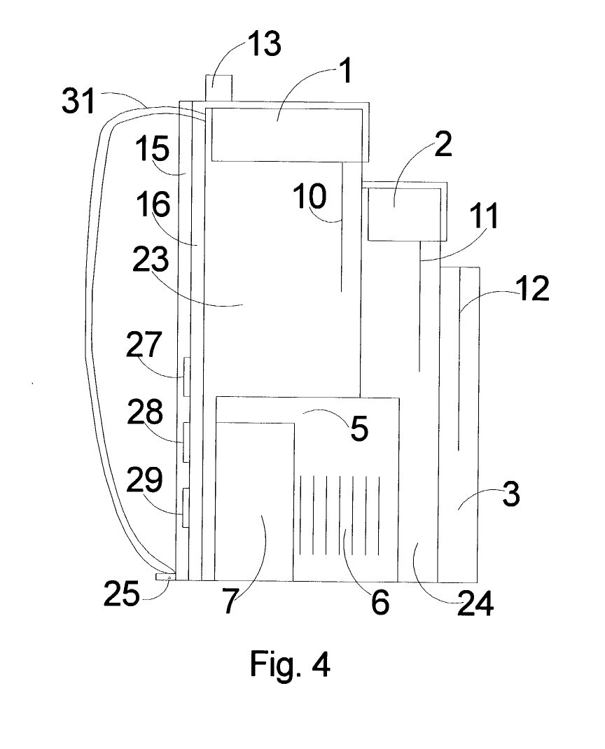

FIG. 5 is a sectional view of the left side of the present invention, motorcycle case and backpack that protects computers.

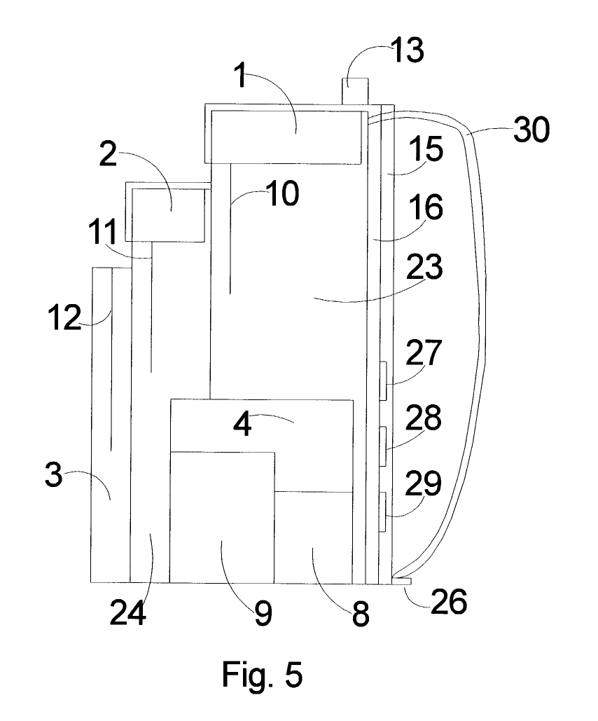

FIG. 6 is a plan view of the rear panel of the largest compartment of the present invention, motorcycle case and backpack that protects computers.

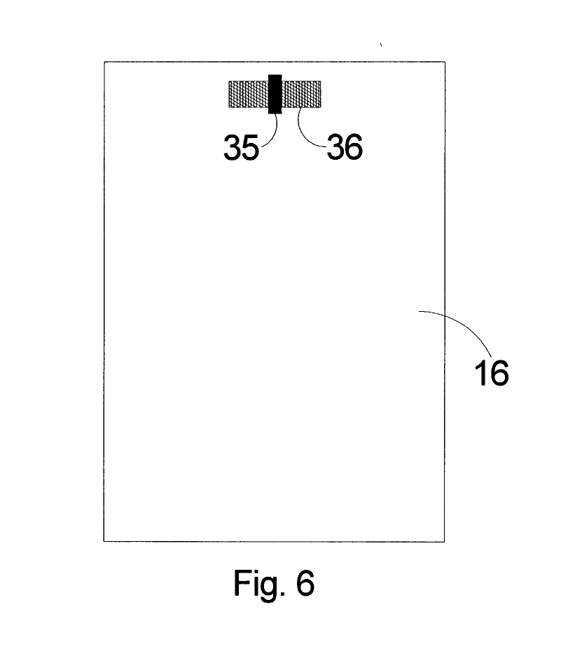

### DESCRIPTION OF THE PREFERRED EMBODIMENT

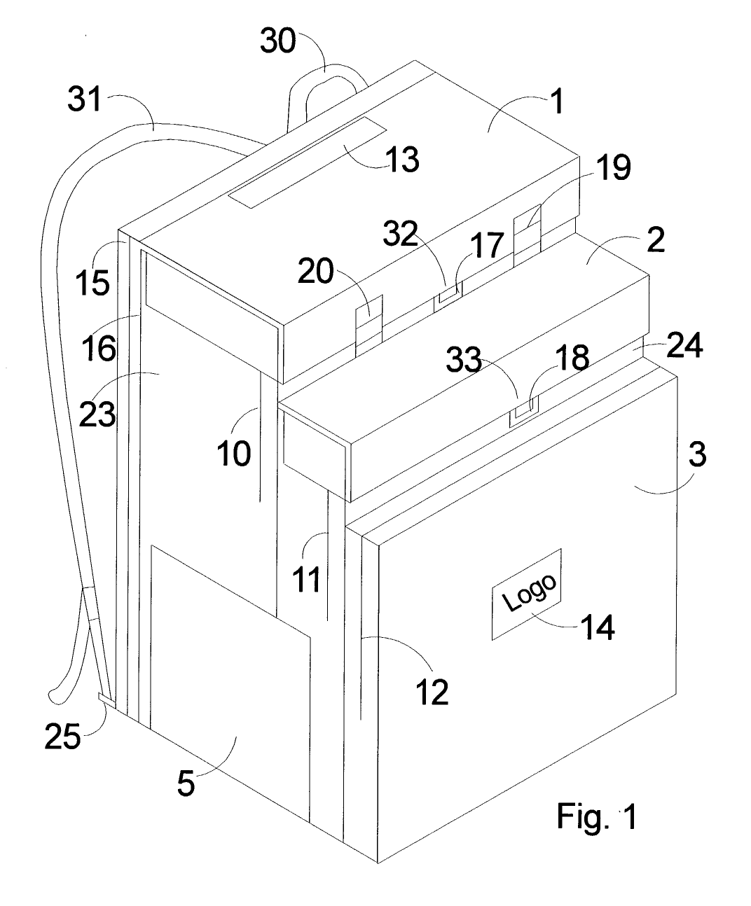

Referring to the entirety of FIG. 1, there is shown a perspective view of the present invention, a motorcycle backpack for laptop computers. Sides of the device not revealed in FIG. 1 have the same general structure as those sides that are depicted.

The present device has top covers 1 and 2 designed to fit over compartments 23 and 24, respectively. Compartments 23 and 24 contain zippers 10 and 11, respectively, which travel across their tops and down both sides of compartment 23 and 24. Top cover 1 and 2 will be secured in place by Velcro tabs 32 and 33, respectively, in its center, front portion where metal D-rings 17 and 18 should be attached so they may easily be pulled up.

Top cover 1 has a bag handle 13 located in its center, rear portion. Bag handle 13 will be given a rounded shape in its center portion by having leather material wrapped and stitched around it.

To prevent top cover 1 from being pulled up when bag handle 13 is grabbed, two straps 19 and 20 will be stitched to the front of top cover 1 and compartment 23. They will function like a belt buckle, with the top strap, which will be stitched to top cover 1, being the portion with holes set one inch apart and the bottom strap, which will be stitched to compartment 23, being the portion with the buckle that the top portion is looped through.

Compartment 23 will have a rectangular ring of metal 35 mounted centrally on its inner rear wall 16 for the purpose of carrying clothes on a hanger. The rectangular ring of metal 35 will be securely stitched to the inner rear panel 16 via a piece of leather 36.

The third and smallest compartment 3 will be furthest from the wearer's back. Compartment 3 will have a zipper 12 that travels across its top and down both sides. Centered on the front facing of compartment 3 will be a company logo 14.

The rear panel 16 of compartment 23 will be composed of two layers of material. The two layers of material will function as a pocket that the two detachable backpack straps 30 and 31 may slide into when they are not clipped onto metal D-rings 25 and 26. There will be a zippered opening 34 at the top of the present invention from which the straps 30 and 31 emerge. Backpack strap 30 is curved like an “S” and backpack strap 31 is curved like a backwards “S” so when a person wears the backpack the straps will curve around the wearer's neck and chest in a comfortable and natural manner. The uppermost portion of backpack straps 30 and 31 will be stitched to the top of the bag beneath and inside the zippered opening 34, using the side of the pocket that comprises the wall of compartment 23. Backpack straps 30 and 31 will be sewn to the bag. Then, another layer of material 32 will be placed on top of the ends of the straps where this “X” pattern is and sewn into place to anchor them securely. The remaining length of backpack straps 30 and 31 will be designed to shift direction every third of their distance to create the “S” and reversed “S” pattern.

The outer layer of the backpack strap pocket 16 will have three horizontal straps 27, 28, and 29 stitched to it for the purpose of attaching the present invention to a motorcycle's backrest bar (sissy bar). Each horizontal strap 27, 28, and 29 will have Velcro attached to the ends so that after the straps have been wrapped around the motorcycle's backrest in a hook-and-loop manner the present invention will be held securely in place. A metal D-ring will be attached to the end of the portion of horizontal straps 27, 28, and 29 that will be on the outside when the Velcro straps are laid on top of each other to secure the present invention to the motorcycle's backrest.

A padded flap 15 that covers the back of the largest compartment 23 will be attached to the back of the present invention with a zipper to prevent the three horizontal motorcycle attachment straps 27, 28, and 29 from irritating the back of a person who is wearing the invention as a backpack. The padded flap 15 will have a zipper that goes all the way around the sides and top of the bag. The padded flap 1S will not cover the zippered opening 34 for the backpack straps 30 and 31. The stitching for the three horizontal motorcycle attachment straps 27, 28, and 29 will be far enough away from the padded flap's 15 zipper so that the zipper will be able to move freely.

The present invention will have a compartment on its right side 5 that will contain inner pockets 6 and 7. Pocket 6 will consist of a series of looped material designed to hold objects such as pens. Pocket 7 will be designed to contain an object such as a cellular telephone.

The present invention will have a compartment on its left side 4 that will contain inner pockets 8 and 9. Pocket 8 will be designed to contain an object such as a business card holder. Pocket 9 will be designed to contain an object such as a wallet.

Although specific embodiments of the present invention will be described below, it should be understood that such embodiments are given merely to be illustrative of a few specific embodiments out of many that might be used to create such a device. One skilled in the art of manufacturing could make such a device with various materials, such as leather, nylon, or cotton. Various changes and modifications obvious to one skilled in the art to which the present invention pertains are deemed to be within the spirit, scope, and contemplation of the present invention that is further defined in the following claims.

What is claimed is:

1. A computer case that may be worn as a backpack or attached to a motorcycle, comprising:
a. a dual-strapping system that will enable the case to be used as a backpack by a person walking or as motorcycle luggage by a person riding;
b. whereby a system of panels is constructed to prevent the horizontal and vertical straps from interfering with one another when the present invention is being used in its backpack mode or its motorcycle luggage mode.

2. The computer case of claim 1 is further comprised of a central compartment with padding between the layers of material sufficient to protect a laptop computer that is transported about on a daily basis by hand and motorcycle.
a. The central compartment of claim 2 will be sheltered by a covering that extends over its front and sides that will protect the contents from rain while riding or walking.

3. The computer case of claim 1 is comprised of a rectangular ring of metal and leather straps affixed to the largest compartment for the purpose of hanging clothes while using the present invention.
